(19) United States
(12) Patent Application Publication
(10) Pub. No.: US 2026/0252893 A1
(43) Pub. Date: Aug. 27, 2026

(54) ANOMALY DETECTION SYSTEM AND METHOD

(71) Applicant: STMicroelectronics International N. V., Geneva (CH)

(72) Inventors: Angelo Bosco, Giarre (CT) (IT); Filippo NACCARI, Tremestieri Etneo (IT)

(21) Appl. No.: 19/547,106

(22) Filed: Feb. 23, 2026

(30) Foreign Application Priority Data
Feb. 25, 2025 (FR) 2501910

(51) Int. Cl. G06N 3/0895

(52) U.S. Cl. CPC G06N 3/0895

(57) ABSTRACT

The present disclosure relates to an anomaly detection system and method, the system configured to, in an in-situ learning phase or in an inference phase, acquire a data stream; and determine a M*N sketch matrix (S_{i,j}) by using a Count-Min sketching algorithm (CMS) based on hash functions (hᵢ(x)) of hash keys (x) associated with the data stream. Each of the hash functions (hᵢ(x)) comprising a p-stable random projection matrix (Πᵢ) multiplied by the hash keys x, onto a direction of a p-stable random vector (lᵢ).

### CROSS-REFERENCE TO RELATED APPLICATIONS

This application claims the priority benefit of French patent application number FR2501910, filed on Feb. 25, 2025, entitled “Anomaly detection system,” which is hereby incorporated herein by reference to the maximum extent allowable by law.

### TECHNICAL FIELD

The present disclosure relates generally to anomaly detection systems and their related methods.

### BACKGROUND

Processing data directly on an edge device or system, such as a microcontroller, is improving thanks to the joint advancements in algorithms and specialized hardware. Such processing is for example used for neural inference. However, the ability to perform learning on the device or system itself still lags significantly behind, due to the computational and memory requirements. For example, standard gradient descent used in backpropagation for training neural models generally requires a larger amount of resources than is available at the scale of a microcontroller.

Embedded devices, such as anomaly detection systems, are an example of systems for which it would be desirable to be able to perform training phases with very limited resources.

### SUMMARY

There is a need to provide a device, for example using a microcontroller, able to perform learning tasks without using a large amount of resources.

Furthermore, there is a need to provide an anomaly detection system able to perform learning tasks without using large amount of resources.

One embodiment addresses all or some of the drawbacks of known devices.

One embodiment provides an anomaly detection system configured to, in an in-situ learning phase and/or in an inference phase:
acquire a data stream; and
determine a M*N sketch matrix S_{i,j} by using a Count-Min sketching algorithm (CMS) based on hash functions hᵢ(x) of hash keys (x) associated with the data stream;
each of the hash functions hᵢ(x) comprising a projection, of a p-stable random projection matrix Πᵢ multiplied by the hash keys x, onto a direction of a p-stable random vector lᵢ.

One embodiment provides an in-situ anomaly detection method comprising, in an in-situ learning phase and/or in an inference phase:
acquiring a data stream; and
determining a M*N sketch matrix S_{i,j} by using a Count-Min sketching algorithm (CMS) based on hash functions hᵢ(x) of hash keys (x) associated with the data stream; each of the hash functions hᵢ(x) comprising a projection, of a p-stable random projection matrix Πᵢ multiplied by the hash keys x, onto a direction of a p-stable random vector lᵢ.

According to an embodiment, each of the hash functions hᵢ(x) is as the following equation:

$${h}_{i} ( x ) = [ \frac{{l}_{i} ( {\prod }_{i} x ) + {O}_{i}}{w} ] mod N , i = 1 , … , M , \qquad [ Math 1 ]$$

lᵢ (Πᵢx) designating the projection, of the p-stable random projection matrix Πᵢ multiplied by the hash keys x, onto the direction of the p-stable random vector lᵢ;
Oᵢ designating a random offset;
w designating a bucket S[i, j] width of the respective sketch matrix.

According to an embodiment, the sketch matrix (S_{i,j}), determined during the learning phase, is used to obtain an estimated occurrence of each hash key x in normal conditions.

According to an embodiment, an anomaly is detected in the data stream acquired during the inference phase, if the following equation is satisfied:

$$\text{?} ( min \{ S [ i , {h}_{i} ( x ) ] \} \begin{matrix}M \\ i = 1\end{matrix} ) < τ \qquad [ Math 3 ]$$

τ designating the minimum frequency of hash key x determined during the learning phase, and [symbol] designating an indicator function, whose value is 1 when a predicate in its argument is true, S[i, hᵢ(x)] being buckets of the sketch matrix obtained during the inference phase.

According to an embodiment, in an inference phase, the sketch matrix is queried and an anomaly is detected, in another data stream, if the following equation is satisfied:

$$\text{?} ( min \{ S [ i , {h}_{i} ( x ) ] \} \begin{matrix}M \\ i = 1\end{matrix} ) < τ , \qquad [ Math 3 ]$$

τ designating the minimum frequency of hash key x determined during the learning phase, and [symbol] designating an indicator function, whose value is 1 when a predicate in its argument is true.

According to an embodiment, τ is determined by the following equation:

$$τ = {min}_{i , j} ( \text{?} ( {S}_{i , j} \neq 0 ) ) S [ i , j ] , ∀ i , j \qquad [ MATH 2 ]$$

According to an embodiment, τ is determined by:
determining a subset of the smallest non-zero elements of the matrix (S_{i,j});
iteratively updating the subset by removing items of the subset until the variance of the updated subset becomes smaller than a given tolerance;
τ being equal to the average of the updated subset having its variance smaller than the given tolerance.

According to an embodiment, each bucket S[i, j] of the matrix (S_{i,j}) comprises a counter which increments when a floor function of the corresponding hash function hᵢ(x) of index i results in j, i=1, . . . , M.

According to an embodiment, the counter increments according to the following equation:

$$S [ i , ⌊ {h}_{i} ( x ) ⌋ ] = S [ i , ⌊ {h}_{i} ( x ) ⌋ ] + 1 , i = 1 , … , M . \qquad [ MATH 4 ]$$

According to an embodiment, the counter increments with a value T which depends on a fractional result of the corresponding hash function hᵢ(x).

According to an embodiment, the counter is incremented according to the following equations:

$$S [ i , ⌊ {h}_{i} ( x ) ⌋ ] = S [ i , ⌊ {h}_{i} ( x ) ⌋ ] + T ( {h}_{i} ( x ) , c , σ ) . \qquad [ MATH 5 ]$$

$$T ( {h}_{i} ( x ) , c , σ ) = W \cdot exp ( - \frac{{( {h}_{i} ( x ) - c )}^{2}}{2 {σ}^{2}} ) . \qquad [ MATH 6 ]$$

W being a desired maximum weight, c being the bucket center, for example 0.5. σ being a width of a Gaussian distribution.

According to an embodiment, dot products zᵢ=lᵢΠᵢ are computed and stored in a look up table, prior to zᵢx computation of the hash functions hᵢ(x).

According to an embodiment, the hash keys x are vectors associated with the data; hash keys x being for example, frequency vectors, or normalized vectors, or normalized frequency vectors.

According to an embodiment, the projection matrix II is randomly sampled from a p-stable distribution, for example from a normal distribution or from a normal distribution comprised between 0 and 1.

According to an embodiment, the projection matrix Πᵢ is randomly sampled using given seeds γᵢ, for example comprised between 0 and 1.

According to an embodiment:
the p-stable random vectors lᵢ are randomly sampled from a p-stable distribution, for example from a normal distribution, or from a normal distribution comprised between 0 and 1.

According to an embodiment, a first device 50 of the system is configured to calculate the hash functions hᵢ(x) and the sketching matrix is stored in a second device 200, of the system, external to the first device 50.

According to an embodiment, a first device 50 of the system is configured to calculate the hash functions hᵢ(x) and the sketching matrix is stored in a second device 200, of the system, external to the first device 50, the first device being a microcontroller.

According to an embodiment, the data stream is stationary or non-stationary.

According to an embodiment, the system is a microcontroller.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically illustrates an electronic device with on-device learning according to an example embodiment of the present disclosure;

FIG. 2 represents, in the form of functional blocks, an anomaly detection device according to an embodiment;

FIG. 3 represents, in the form of functional blocks, an anomaly detection system according to an embodiment;

FIG. 4 represents functional blocks of FIG. 2 or 3 in more detail;

FIG. 5 represents functional blocks of FIG. 2 or FIG. 3 in more detail;

FIG. 6 and FIG. 7 illustrate functional block of FIG. 2 or 3 in more detail;

FIG. 8 is a chart detailing a functional block of FIG. 2 or 3; and

FIGS. 9 and 10 illustrate an anomaly detection graph as function of a motor rotation speed according to one example.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front,” “back,” “top,” “bottom,” “left,” “right,” etc., or to relative positional qualifiers, such as the terms “above,” “below,” “higher,” “lower,” etc., or to qualifiers of orientation, such as “horizontal,” “vertical,” etc., reference is made to the orientation shown in the figures.

Unless specified otherwise, the expressions “around,” “approximately,” “substantially” and “in the order of” signify within 10% or 10°, and preferably within 5% or 5°.

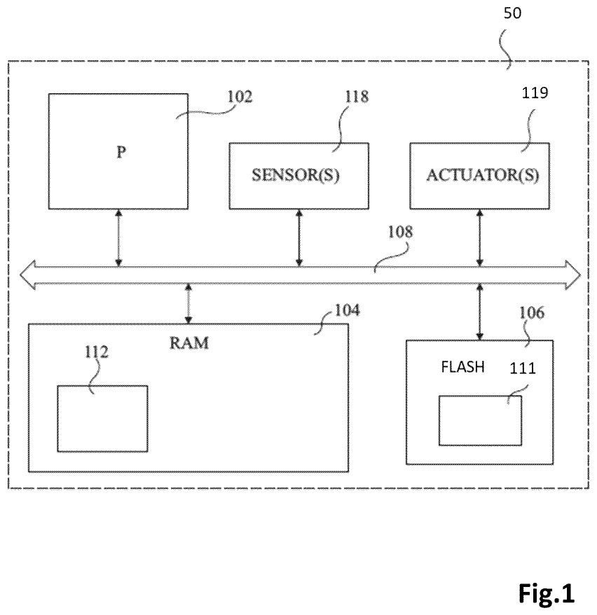

FIG. 1 schematically illustrates an electronic device or system 50 with on-device learning according to an example embodiment of the present disclosure. In the text, the electronic device 50 is also called an endpoint or an edge device. The device 50 is for example an IoT (Internet of Things) edge device, capable of sensing, processing, storing information and actuation of any outcome of the processing. The device 50 can also be for example a microcontroller or a circuit board.

The device 50 for example comprises a processing device (P) 102 having one or more processors under control of instructions stored in a non-transitory memory 104 (RAM) of the device. The memory 104 is for example a volatile memory, such as a random-access memory (RAM). The one or more processors of the processing device 102 are for example CPUs (Central Processing Units), MCUs (Micro-controllers), NPUs (Neural Processing Units), and/or GPUs (Graphics Processing Units).

The electronic device 50 also for example comprises a non-volatile memory 106 (FLASH), which is for example a Flash memory. The processing device 102 is for example coupled to the memories 104 and 106 via a bus 108. The non-volatile memory 106 for example stores, in a region 111, results of functions, for example hash functions, calculated during an inference phase or during a learning phase.

During learning or inference phases, the results of functions, for example hash functions, are for example stored or loaded in a region 112 of the volatile memory 104. In an example, the results of functions, for example hash functions, can be stored in the inference phase in a memory, and in the learning phase, in another memory.

The electronic device 100 also for example comprises one or more sensors (SENSOR(S)) 118 coupled to the bus 108, and/or one or more actuators (ACTUATOR(S)) 119, coupled to the bus 108. In some embodiments, the sensors 118 provide input features, such as data samples, and the electronic device 50 is configured to perform inference on the input features in order to generate one or more predictions, labels or measures. The electronic device 50 is also for example configured to control the one or more actuators 119 as a function of a result of the inference operation.

The one or more sensors 118 for example comprise one or more image sensors, inertial units such as accelerometers or gyroscopes for example, or motors, or microphones etc.

The one or more actuators 119 for example comprise an electric motor control loop, a steering or breaking system for a vehicle, or an electronic actuator, which is for example configured to control the operation of one or more circuits, such as waking up a circuit from sleep mode, causing a circuit to enter into a sleep mode, causing a circuit to generate a text output, to perform a data encoding or decoding operation, etc. For example, in one embodiment the actuators 119 comprise a control circuit causing the generation and transmission of a data packet by the device 50 comprising sensor data from the one or more sensors 118, and/or data generated based on the sensor data.

The process of training neural networks is known for its large resource requirements that far exceed, generally by orders of magnitude, what is possible to achieve on a tiny endpoint, also called edge system or device, such as a microcontroller. In general, learning to perform a task requires far more resources than simply performing the task that has already by learned. Neural networks and non-data oblivious machine learning algorithms involve access to training data and significant processing power to implement learning, which is often offloaded to a powerful host.

Moreover, in the context of neural networks, gradient descent is the pillar of the ubiquitous backpropagation algorithm that searches the optimal neural weights to accomplish an assigned downstream task by iteratively minimizing a loss function over training and validation data, with the expectation that the trained model generalizes well on unseen test data. In practice, neural processing is highly optimized for inference, but is not efficient enough in the inverse direction of learning.

In many cases, anomaly detection systems or other systems require an in-situ learning phase.

There is therefore a need to enable in-situ learning more efficiently to be able to perform it using small endpoints such as microcontrollers.

The computationally intensive nature of backpropagation and gradient descent significantly limits the feasibility of implementing in-situ learning effectively using neural-only techniques. Intuitively, one would select the Stochastic Gradient Descent (SGD) as the best candidate for on-device, or in-situ, learning, as it triggers a backpropagation step for every new sample presented to the optimizer, instead of waiting for the entire training set or a mini-batch of samples. However, the requirement of potentially processing many samples persists or even increases as weight updates are more frequent but less informed, producing a noisier path through the loss landscape towards a minimum of the loss function. In an open set evolutive streaming scenario, where new classes can emerge and samples are continuously generated, it is hard to use SGD. It is difficult to determine when sufficient data has been processed to halt the learning process. If learning starts from scratch, there is no validation data to start with. Other drawbacks include instability of inference while the model is being trained or updated, and Catastrophic Forgetting (CF), which inhibits Class-Incremental Learning, as adding knowledge to a pretrained network may cause the previously learned data to be forgotten. CF compensation exposes the model to intransigence, i.e., resistance to learning new tasks.

Given the limitations discussed above, the embodiments disclosed in the present description address the challenges of on-device or on-system learning.

The embodiments of the present description provide an anomaly detection system configured to, in an in-situ learning phase and/or in an inference phase:
acquire a data stream; and
determine a M*N sketch matrix S_{i,j} by using a Count-Min sketching algorithm (CMS) based on hash functions hᵢ(x) of hash keys (x) associated with the data stream; each of the hash functions hᵢ(x) comprising a p-stable random projection matrix Πᵢ multiplied by the hash keys x, onto a direction of a p-stable random vector lᵢ.

The proposed embodiments differ from a neural network approach which, in the use case of an anomaly detection system, is typically solved using distance metrics and autoencoders. In this case of neural networks, data from sensors are stored and used for offline model training on a sufficiently powerful host, and once the model is trained and optimized, it can be deployed on the edge device.

In contrast to a neural network approach, in the presented embodiments, the anomaly detection tasks in dynamic data streams consist in learning the normal, otherwise said “standard,” conditions directly in-situ. Thus, the presented embodiments propose a novel application for anomaly detection among a set of multiple normal conditions, eliminating the need of pre-acquiring any static dataset for offline processing. All data is processed on-the-fly while it is being generated and observed. Samples are processed once, and then they are lost. Frequently occurring items in the data stream can be related to normal conditions, whereas rarely or never observed items can be associated to anomalies. As more samples are processed, the reliability of the system increases.

In the proposed embodiments, the static concept of offline datasets is replaced by processing data on-the-fly, while data samples are being generated and observed. Such an approach helps to minimize storage and computational requirements to achieve an in-situ learning system.

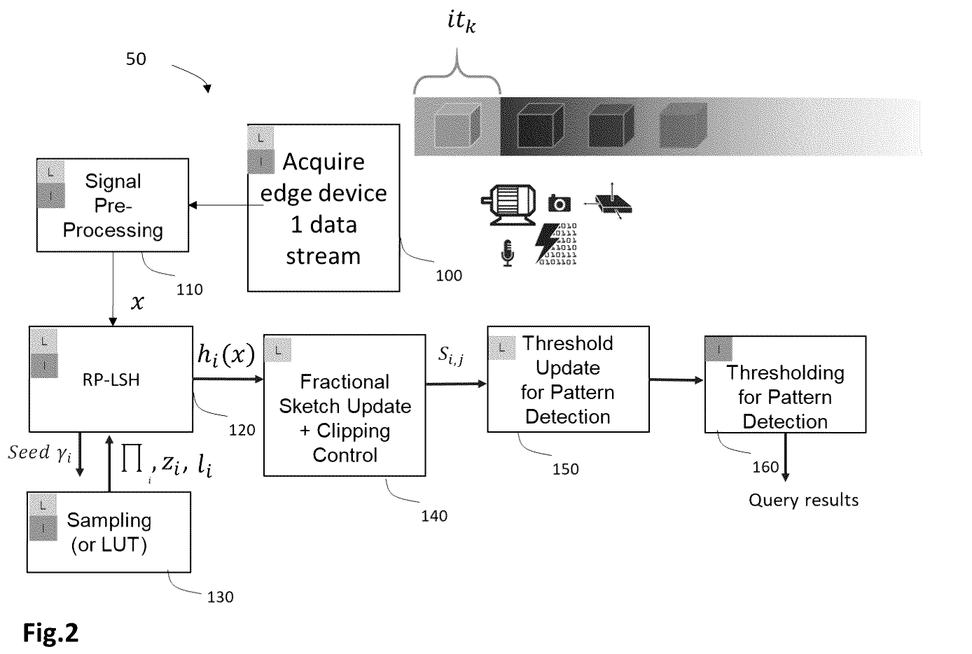

FIG. 2 represents, in the form of functional blocks, an anomaly detection device 50 according to an embodiment.

The device 50 of FIG. 2 forms an endpoint that uses on-device learning implemented via streaming algorithms, which are performed entirely on the endpoint. In this example, significant data storage is not necessary and could be substituted at most by a very small amount of memory (for example memories 111 or 112) to store some buffered data for implementing windowed processing.

The presented system with on-device learning uses a sketch data structure and a streaming algorithm. The sketch (which is in a form of a matrix) represents an approximate summary of the data. The streaming algorithm performs a dual task: it updates the sketch and queries it. Streaming algorithms can be less accurate than classic neuron network solutions. However, their estimates are good enough to solve certain classes of problems, such as anomaly detection, and theoretical error bounds can be obtained.

Sketching is the process of synthesizing information about the data stream and storing it in a probabilistic data structure known as the sketch, which can be viewed as an approximate summary of the data observed so far. The sketch should fit in the limited memory of the device 50. The sketch can be used before the underlying data stream has terminated. This contrasts with the typical neural approach in which the model is not usable until the training process is halted, i.e., when a certain minimum of the loss landscape has been reached. The use of a sketch allows fast processing and reduction of memory and bandwidth requirements, which is useful in case the device 50 is a sensor or other device that is to communicate data to another device; for example, sketches can be sent instead of the actual data. Moreover, sketches can be merged, allowing adding information without losing or forgetting information.

The system 50 of FIG. 2 uses normal data streams, represented as cubes, which are possibly infinite sequences of items noted itₖ. The “normal” term means here that the data corresponds to normal, or standard, working conditions without transitions or damages, for example. In an example, items itₖ can be raw data, or can embedding vectors, obtained from signals generated by one or more IoT sensors, or inertial sensors, or microphones etc. In an example, the items itₖ are numerical vectors x, for example Fast Fourier Transforms (FFT) frequency vectors. Once an item itₖ has been observed, all or part of past items itₚ, p<k, cannot be accessed as they are not stored. In an example, only a small number of buffered items may be available, depending on the memory in the endpoint device 50.

In an example, the data streams can be stationary, where data samples are drawn from a fixed, initially unknown, probability distribution, or non-stationary, where data can evolve over time and transient behaviors are possible. In the latter case, drift detectors are for example implemented to detect changes in the statistical properties of the data stream.

In a step 100 (Acquire edge device 1 data stream), which is implemented during the learning and the inference phases (L and I boxes in the figures), data streams are acquired by the device. Data can for example be related to acceleration, speed, frequencies, to images, electromagnetic fields, sound, or to any kind of signal measurable by a physics, chemistry, or medical sensor or the like.

In a further step 110 (Signal Pre-Processing), which is optional and which is implemented during the learning and the inference phases, the endpoint device 50 pre-processes the data stream signals, for example by computing a Fast Fourier Transform operation to obtain numerical vectors x.

In steps 120 (RP-LSH), 130 (Sampling or LUT), and 140 (Fractional Sketch Update+Clipping Control), posterior to step 110, an algorithm, which is based on a Count-Min Sketching (CMS) algorithm approach, is performed. A CMS algorithm allows to find the most frequent items in a stream, with Locality Sensitive Hashing (LSH) and randomization.

In the represented example, steps 120 and 130 are implemented during the learning and the inference phases. Step 140 is implemented during the learning phase only.

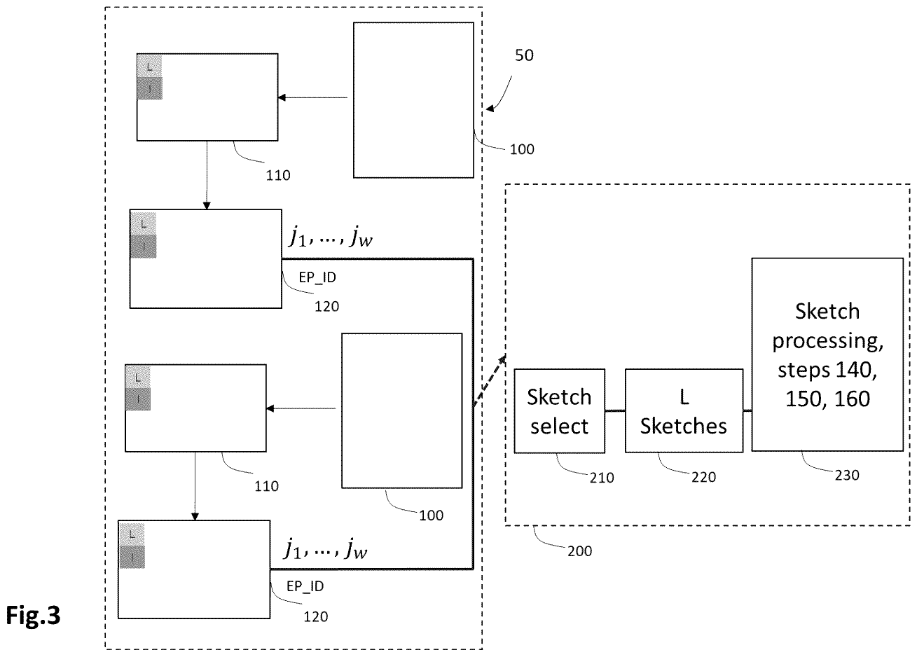

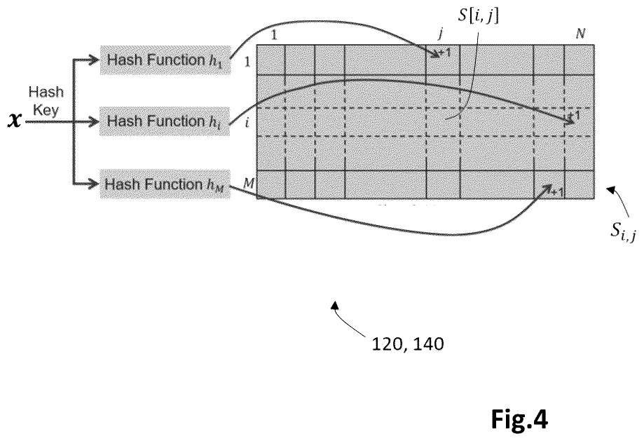

CMS uses multiple hash functions hᵢ(x), i=1, . . . , M and a sketch matrix S_{i,j} of size M×N, which serves as a probabilistic data structure. The hash functions hᵢ(x), given a key vector x as argument, each produce a scalar output, which is used as an index into the matrix S_{i,j}. The matrix S_{i,j} has as many rows as the number of selected hash functions hᵢ(x); unlike standard hash tables, each entry of the sketch matrix does not store items, but simply contains a counter that is incremented every time an item is hashed into it. The hash-key x for the hash functions can be set equal to a feature vector obtained from the data, and it is hashed into the sketch matrix using all M hash functions, updating the corresponding frequency counter in each row. In other words, each hash function hᵢ(x) produces a column index in the associated row of the sketch S_{i,j}. An example of the sketching process is described in relation with FIGS. 3 and 4.

The sketch matrix S_{i,j}, determined during the learning phase, is used to obtain an estimated occurrence of each hash key x in normal conditions.

In step 120, the hash functions hᵢ(x) are chosen independently from the data distribution. In other words, data-oblivious Locality Sensitive Hashing (LSH) is achieved.

LSH implements hashing by means of a family of hash functions that hash similar items in the same bucket with high probability. Specifically, the present embodiments aim at maximizing collisions for similar items ensuring that comparable items are hashed into the same bucket S[i, j] of the sketch matrix S_{i,j}. The amount of similarity is defined by distance metrics and the amount of tolerated noise is application specific.

In the example of FIG. 2, each of the hash functions hᵢ(x) comprises a projection, of a p-stable random projection matrix Πᵢ multiplied by the hash keys x, onto a direction of a p-stable random vector lᵢ. The hash key x can be also the normalized hash key

$$\frac{x}{‖ x ‖}$$

by dividing x by its L₂ norm. The products Πᵢx each has a dimensionality named d.

In an example, each of the hash functions hᵢ(x) is as defined by the following equation:

$${h}_{i} ( x ) = [ \frac{{l}_{i} ( {\prod }_{i} x ) + {O}_{i}}{w} ] mod N , i = 1 , … , M \qquad [ Math 1 ]$$

lᵢ, Πᵢ being matrices enabling the projection of the hash keys x, to produce a d-dimensional projection;
Oᵢ designating a random offset;
w designating a bucket S[i, j] width of the sketch matrix. The hash key x can be also the normalized hash key

$$\frac{x}{‖ x ‖} .$$

The above equation is allowed since, in a distributional Johnson-Lindenstrauss (DJL) lemma, otherwise called the probabilistic formulation of the Johnson-Lindenstrauss (JL) Lemma, known as (ε,δ)-JL or distributional Johnson-Lindenstrauss (DJL) lemma, the projection matrix is 2-stable (p=2).

The high dimensionality of the hash key x can lead to noise in the sketch matrix; in this context, the proposed lᵢ Πᵢ projection leads to a dimensionality reduction that preserve sample distances while being data-oblivious. It ensures similarity between high and low dimensional representations.

In an example, if the matrices Πᵢ are chosen to be normally distributed, then they are p-stable and thus the preservation of distances between higher and lower dimensional spaces is achieved.

In an example, vectors lᵢ have a normal distribution noted (0, I).

As the p-stable random projection matrices Πᵢ can be large matrices, in step 130, which can be optional, it can be useful to sample in-situ the p-stable random projection matrices Πᵢ and the p-stable random vectors lᵢ, using fixed random seeds γᵢ. In an example, the p-stable random projection matrices Πᵢ are d*D matrices.

In another example, in order to limit the storage of the sampled p-stable random projection matrices Πᵢ and of the sampled p-stable random vectors lᵢ, the device 50 or an external computing unit, can pre-compute the dot products zᵢ=lᵢΠᵢ and store them in a look up table (LUT) in the device 50, prior to lᵢ computation of the hash functions hᵢ(x), and then compute zᵢx or

$${z}_{i} \frac{x}{‖ x ‖} .$$

Thus, a LUT can store the M pre-calculated vectors zᵢ. Furthermore, considering the distributional properties of lᵢ and Πᵢ, a Gaussian can be fitted such that zᵢ~N(0, d·I), N being a normal (also called Gaussian) distribution and d being the dimensionality of the vectors lᵢ. This allows allocating space for just a single vector zᵢ. By associating the various fixed random seeds γᵢ to each hash function, the same vector zᵢ can be resampled every time the i-th hash function is called, by sampling zᵢ from (0, d·I; γᵢ), I being the identity matrix. This massively reduces memory requirements from (d+dD) to D coefficients only. In an example, the variance of zᵢ can be set to 1 if the variance of Πᵢ is scaled to 1/d.

As an example, the integer bucket index in the i-th row of the sketch S_{i,j} is obtained with [hᵢ(x)]. In the optional step 140, the remaining exact fractional part of hᵢ(x) is used to determine the distance to the center of the associated sketch bucket. Items hashed in the central range of a bucket are multiplied by a high coefficient prior to the sketch update. Items hashed near the boundaries of the bucket are, on the contrary, multiplied by a lower coefficient. A further example of step 140 is described in relation with FIG. 7.

Regarding the saturation (clipping) of the count values, it can be compensated by scaling all the count values and preserving their relative frequencies, for example by dividing the count values by a constant.

Furthermore, in step 140, a threshold t is determined and defined for example by the following equation:

$$τ = {min}_{i , j} ( \text{?} ( {S}_{i , j} \neq 0 ) ) S [ i , j ] , ∀ i , j \qquad [ Math 2 ]$$

[symbol] designating an indicator function, whose value is 1 when a predicate in its argument is true. Otherwise expressed, in an example, t designates the minimum frequency of the hash keys x determined during the learning phase.

In another example, an alternative strategy to define the threshold, accounting for a non-zero noise floor in the sketch S_{i,j}, consists in considering a subset of the smallest non-zero elements of the sketch S_{i,j}, and iteratively removing items until the variance of the subset is smaller than a tolerance. The threshold is then set equal to the average of the subset.

In a step 150 (Threshold Update for Pattern Detection), which is implemented during the learning phase only and after steps 120, 130, 140, the threshold t is updated following equation MATH 2.

In a step 160 (Thresholding for Pattern Detection), which is implemented in the inference phase, after step 120, the sketch matrix is queried and an anomaly is detected (Query results), in another data stream coming after the data streams used for training, e.g. a data stream acquired during the inference phase, if the following equation is satisfied:

$$\text{?} ( min \{ S [ i , {h}_{i} ( x ) ] \begin{matrix}M \\ i = 1\end{matrix} ) < τ . \qquad [ Math 3 ]$$

S[i, hᵢ(x)] being, in this equation, buckets of the sketch matrix obtained during the inference phase.

FIG. 3 represents, in the form of functional blocks, an anomaly detection system according to an embodiment.

The system of FIG. 3 comprises for example the same functional blocks as in the example of FIG. 2 but the steps 140, 150 and 160 are implemented outside of the endpoint 50, for example in a remote server, cloud, gateway or a remote computer 200. The anomaly detection system of FIG. 3 consists, in this example, in the device 50 and the device 200. In this example, the functions hᵢ(x) are calculated in situ by the endpoint 50 but the sketch S_{i,j} is built remotely in device 200.

In the represented example, the system of FIG. 3 comprises for example L edge devices, each having a different identity EP_ID, each of the L devices processing a different data stream from a different sensor, using the functional blocks 120. Further functional blocks are processed remotely. The results j₁, . . . , j_{w} of the respective blocks 120 are sent to the remote device 200. In an example, the last sub index of j_{w} is w which means that the associated sketch matrix has w rows.

The remote device comprises for example a sketch selection block 210 (Sketch select) which selects, for example according to their EP_ID reference, the sketch to be filled according to the respective block 120.

Once the respective sketch is selected, it is processed using for example blocks 220 (L Sketches) and 230 (Sketch processing, steps 140, 150, 160), which perform for example the functions of the blocks 140, 150 and 160 of FIG. 1.

The example of FIG. 3 allows a reduction of the memory needed in the endpoint device 50, which does not need to store the sketch matrix S_{i,j} anymore.

FIG. 4 represents functional blocks of FIG. 2 or 3 in more detail.

More particularly, FIG. 4 represents an example of the blocks 120, 140, which correspond to the building of the sketch matrix S_{i,j}. The hash functions hᵢ(x), given a key vector x as argument, each produce a scalar output which is used as a column index of the matrix S_{i,j}. Each entry of the sketch matrix does not store items, but simply contains a counter that is incremented every time an item is hashed into it.

In an example, given a sketch matrix S_{i,j} of size M×N initialized to all zeroes, for each input hash-key vector x, the sketch is updated by using counter (sketch update counter) increments according to the following equation:

$$S [ i , ⌊ {h}_{i} ( x ) ⌋ ] = S [ i , ⌊ {h}_{i} ( x ) ⌋ ] + 1 , i = 1 , … , M . \qquad [ MATH 4 ]$$

In another example, the exact fractional position of hᵢ(x) of equation MATH 1 is used to increment the counter differently according to the position in the bucket. For example, a larger sketch update is performed for items hashed in the central range of a bucket and a lower is performed near its boundaries. The reason for this is that items hashed near the boundaries are more likely to cross over adjacent buckets leading to collisions, for example because of noise.

The distance to the center of the associated sketch bucket is given by the exact fractional part of hᵢ(x) related to the post modulo-N bucket [hᵢ(x)].

In another example, the sketch update counter is incremented according to the following equations:

$$S [ i , ⌊ {h}_{i} ( x ) ⌋ ] = S [ i , ⌊ {h}_{i} ( x ) ⌋ ] + T ( {h}_{i} ( x ) , c , σ ) . \qquad [ MATH 5 ]$$

$$T ( {h}_{i} ( x ) , c , σ ) = k \cdot exp ( - \frac{{( {h}_{i} ( x ) - c )}^{2}}{2 {σ}^{2}} ) . \qquad [ MATH 6 ]$$

k being a desired maximum weight, c being the bucket center, for example equal to 0.5. σ being a width of a Gaussian distribution.

In an example, to determine the dimensions of the sketch matrix, it can be advantageous to set

$$N = [ \frac{1}{{D}^{\frac{1}{d}}} D ] ,$$

where d<D is chosen according to the distributional Johnson-Lindenstrauss (DJL) lemma. If we assign a memory budget of C entries to S_{i,j}, then

$$M = ⌊ \frac{C}{N} ⌋ .$$

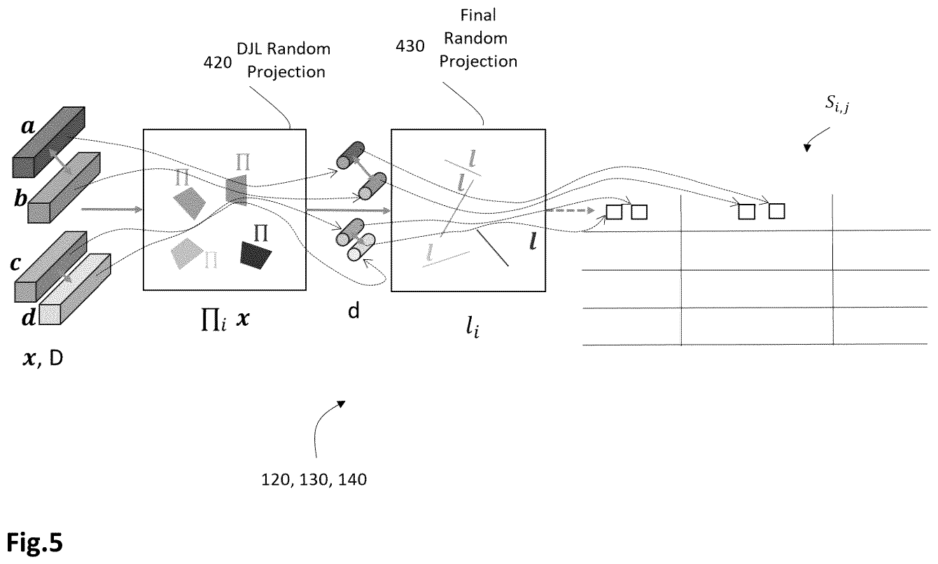

FIG. 5 represents functional blocks of FIG. 2 or FIG. 3 in more detail.

More particularly, the example of FIG. 5 represents the functional blocks 120, 130 and 140 in more detail.

In the represented example, a, b, c and d are sets of samples (i.e. hash-key vectors x), each having a dimensionality D.

Sets a and b have a first algebraic distance between them, and sets c and d have a second algebraic distance between them.

In a step 420 (DJL Random Projection), the p-stable projection matrix Πᵢ is applied on the hash-keys x, the resulting dimensionality of each projection matrix Πᵢ x is reduced from D to d. Thanks to the fact that each projection matrix Πᵢ has a normal distribution, the projection matrix Πᵢ used in DJL is 2-stable (p=2). This property allows to plug the DJL lemma into the LSH function definition without violating the p-stable property, reducing the dimensionality of the hash-keys. The original algebraic distance between sets a and b, and similarly for sets c and d, is roughly, i.e. within a moderate error, kept during this transformation.

In a step 430 (Final Random Projection), the result of Πᵢ x is projected onto the direction of the p-stable random vectors lᵢ.

In an example, lᵢ and Πᵢ x projections are quasi-random orthogonal projections from p-stable distributions which allows to implement locality sensitive hashing (LSH).

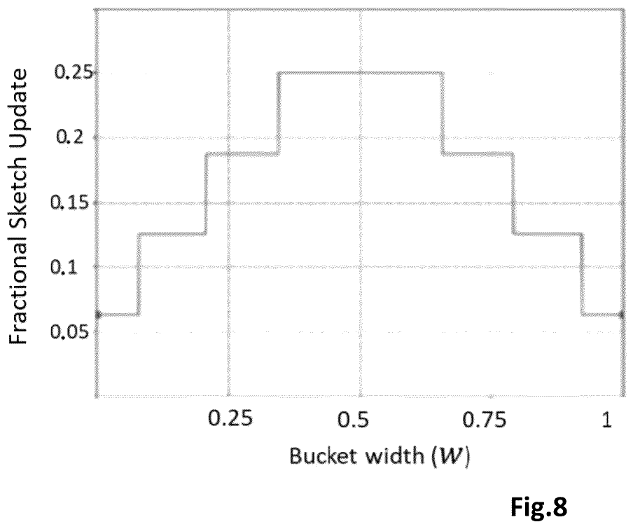

In the represented example, the step 430 produces scalar outputs, which are used as column index of the matrix S_{i,j}. This column index is then used to update the counter of the corresponding column. Neighbor scalars are counted in a same bucket (adjacent squares in the sketch S_{i,j} of FIG. 4). The counting update can be for example as in equation MATH 4, or as in equations MATH 5 and MATH 6, or as proposed hereafter in relation to FIG. 8.

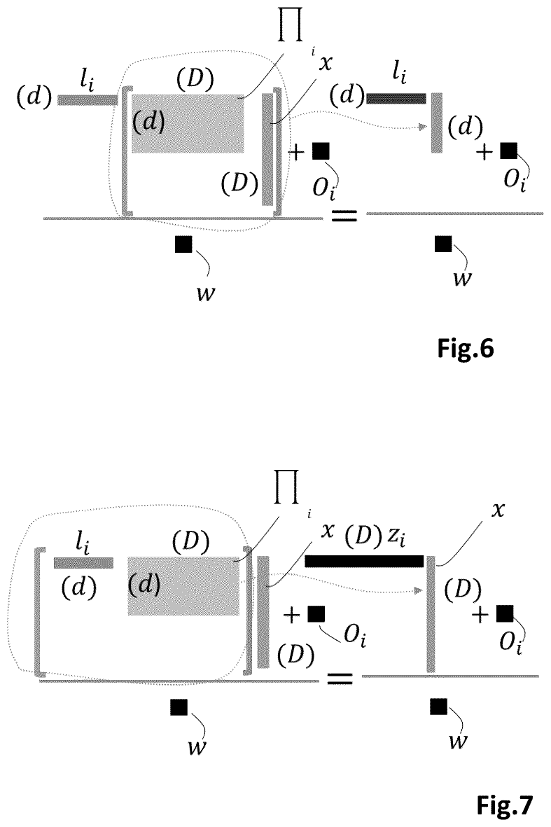

FIG. 6 and FIG. 7 illustrate functional block of FIG. 2 or 3 in more detail.

More particularly, FIGS. 6 and 7 are examples of how to perform the hᵢ(x) computation (shown without modulo function for clarity reasons) of block 120.

In FIG. 6, the projection matrix Πᵢ has a size of d (row)*D(columns). The hash-keys x are arranged in a column with a dimension D. Πᵢ x calculation is performed and the result is arranged in a column with the dimensionality d. The result of Πᵢ x is then projected onto the direction of the p-stable random vectors lᵢ, which are arranged in a row, to give a scalar.

In FIG. 7, the products zᵢ=lᵢΠᵢ are performed first and the results zᵢ are arranged in a row of a dimensionality D. The results zᵢ are then applied to the hash-keys x, which are arranged in a column with a dimension D to obtain a scalar.

In an example, the results zᵢ are sampled to be arranged in a row with 1*D dimensionality or to be directly scalars.

In another example, the results zᵢ are stored directly in a look up table, which takes the index i as input and returns the corresponding result zᵢ.

In an example, zᵢ values are stored in one of the memory 104 or 106.

FIG. 8 is a chart detailing a functional block of FIG. 2 or 3.

The chart of FIG. 8 represents more particularly an example of the fractional sketch S_{i,j} counter update or increment (Fractional Sketch Update), as implemented in the step 140, as a function of the bucket width w (Bucket width (w)).

In the example of FIG. 8, the term T of equation MATH 5 can be represented by a Gaussian bell truncated at the boundaries of the post-modulo N unit length bucket, and is quantized. A look-up table can be used to speed up the computation.

In the represented example, items hashed in the central range (0.5) of a bucket are incremented by a fractional sketch S_{i,j} update coefficient of about 0.25. Items hashed near the boundaries of the bucket are, on the contrary, incremented by a coefficient lower than 0.15.

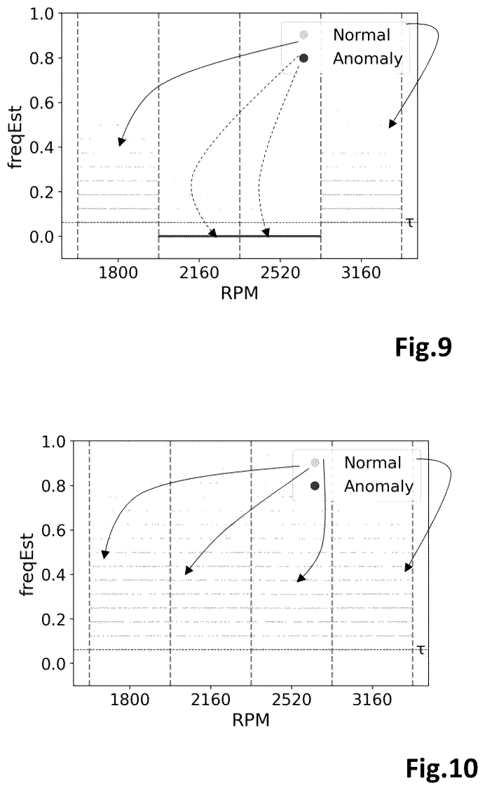

FIGS. 9 and 10 illustrate an anomaly detection graph as function of a motor rotation speed according to one example.

In the example of FIG. 9, hash-keys are FFT frequency vectors obtained with an accelerometer coupled to a motor driving a rotating disk.

The example of FIG. 9 represents more particularly, the estimated frequency of occurrence (freqEst) of a certain item in the data stream as a function of a rotation speed (rounds per minute, RPM) of the rotating disk. freqEst is given by the equation MATH 3.

In the example of FIG. 9, the sketch matrix is updated with vibration data from the motor at 1800 and 3160 RPM constant regimes for the same amount of time, so as to accumulate significant statistics about the data stream. Sketch update is then stopped, although it could be kept active depending on the chosen sketching strategy. The sketch S_{i,j} is then queried with vibration data from the two known speeds (1800, 3160 RPM), and two unknown speeds (2160, 2520 RPM).

As expected, FIG. 9 shows that the first two speeds 1800 and 3160 RPM are detected as known (Normal) (high estimated frequency), whereas the other two are detected as anomalous (Anomaly) (dashed arrows). Due to the fractional sketch update process, the y axis (freqEst), shows a score proportional to the estimated frequency value using equation MATH 3.

In the example of FIG. 10, the sketch update process is unlocked and the motor is now run at the two previously unknown speeds (2160 and 2520), incorporating (updating) them in the sketch, and then querying the sketch S_{i,j} again. FIG. 10 shows that the two additional speeds are now correctly recognized as normal. While operating, the sketch matrix could be periodically filtered to reduce the effects of noise. Saturation of the counters can be compensated by scaling all counters and preserving their relative frequencies. More sophisticated strategies could be put in place to handle transient behaviors.

Being sparse, the sketches are also suitable for compression.

Various embodiments and variants have been described. Those skilled in the art will understand that certain features of these embodiments can be combined and other variants will readily occur to those skilled in the art. In particular, the threshold for detection of an anomaly during the query could be calculated such that, items having an occurrence which is too high as compared to a normal occurrence, could be detected.

Finally, the practical implementation of the embodiments and variants described herein is within the capabilities of those skilled in the art based on the functional description provided hereinabove. In particular, the p-stable projection matrix Πᵢ may be sampled from non-Gaussian distributions. Additionally, the p-stable projection matrix Πᵢ, and the p-stable vector lᵢ, can be pseudo-random as they can be obtained by sampling from pseudo-random seeds. Moreover, the person of the art will use their knowledge to implement the above functional blocks of the device 50 or device 50 and device 200. The device 50 can be a microcontroller, or any device comprising a memory and a computing unit.

What is claimed is:

1. An anomaly detection system comprising:
a non-transitory memory storage comprising instructions; and
one or more processors in communication with the memory storage, wherein the one or more processors execute the instructions to, in an in-situ learning phase and/or in an inference phase:
acquire a data stream; and
determine an M*N sketch matrix (S_{i,j}) using a Count-Min sketching algorithm (CMS) based on hash functions (hᵢ(x)) of hash keys (x) associated with the data stream;
each of the hash functions (hᵢ(x)) comprising a projection, of a p-stable random projection matrix (Πᵢ) multiplied by the hash keys x, onto a direction of a p-stable random vector (lᵢ).

2. The anomaly detection system according to claim 1, wherein each of the hash functions (hᵢ(x)) has the following equation:
$${h}_{i} ( x ) = [ \frac{{l}_{i} ( {\prod }_{i} x ) + {O}_{i}}{w} ] mod N , i = 1 , … , M ,$$
lᵢ (Πᵢx) designating the projection, of the p-stable random projection matrix (Πᵢ) multiplied by the hash keys x, onto the direction of the p-stable random vector (lᵢ);
Oᵢ designating a random offset; and
w designating a bucket (S[i, j]) width of the respective sketch matrix.

3. The anomaly detection system according to claim 1, wherein the sketch matrix (S_{i,j}), determined during the learning phase, is used to obtain an estimated occurrence of each hash key x in normal conditions.

4. The anomaly detection system according to claim 1, wherein an anomaly is detected in the data stream acquired during the inference phase, when the following equation is satisfied:
$$\text{?} ( min \{ S [ i , {h}_{i} ( x ) ] \begin{matrix}M \\ i = 1\end{matrix} ) < τ ,$$
τ designating the minimum frequency of hash key x determined during the learning phase, and [symbol] designating an indicator function, whose value is 1 when a predicate in its argument is true, S[i, hᵢ(x)] being buckets of the sketch matrix obtained during the inference phase.

5. The anomaly detection system according to claim 4, wherein t is determined by the following equation:
$$τ = {min}_{i , j} ( \text{?} ( {s}_{i , j} \neq 0 ) ) S [ i , j ] , ∀ i , j .$$

6. The anomaly detection system according to claim 4, wherein t is determined by:
determining a subset of the smallest non-zero elements of the matrix (S_{i,j}); and
iteratively update the subset by removing items of the subset until the variance of the updated subset becomes smaller than a given tolerance;
τ being equal to the average of the updated subset having its variance smaller than the given tolerance.

7. The anomaly detection system according to claim 2, wherein each bucket (S[i, j]) of the matrix (S_{i,j}) comprises a counter that increments when a floor function of the corresponding hash function (hᵢ(x)) of index i results in j, i=1, . . . , M.

8. The anomaly detection system according to claim 7, wherein the counter increments according to the following equation:
$$S [ i , ⌊ {h}_{i} ( x ) ⌋ ] = S [ i , ⌊ {h}_{i} ( x ) ⌋ ] + 1 , i = 1 , … , M .$$

9. The anomaly detection system according to claim 7, wherein the counter increments with a value T that depends on a fractional result of the corresponding hash function (hᵢ(x)).

10. The anomaly detection system according to claim 9, wherein the counter is incremented according to the following equations:
$$S [ i , ⌊ {h}_{i} ( x ) ⌋ ] = S [ i , ⌊ {h}_{i} ( x ) ⌋ ] + T ( {h}_{i} ( x ) , c , σ )$$
$$T ( {h}_{i} ( x ) , c , σ ) = W \cdot exp ( - \frac{{( {h}_{i} ( x ) - c )}^{2}}{2 {σ}^{2}} ) .$$
W being a desired maximum weight, c being the bucket center, for example 0.5, σ being a width of a Gaussian distribution.

11. The anomaly detection system according to claim 1, wherein dot products zᵢ=lᵢΠᵢ are computed and stored in a look up table, prior to zᵢ computation of the hash functions hᵢ(x).

12. The anomaly detection system according to claim 1, wherein the hash keys x are vectors associated with the data stream, the hash keys x being frequency vectors, or normalized vectors, or normalized frequency vectors.

13. The anomaly detection system according to claim 1, wherein the projection matrix (Πᵢ) is randomly sampled from a p-stable distribution.

14. The anomaly detection system according to claim 1, wherein the projection matrix (Πᵢ) is randomly sampled using given seeds (γᵢ).

15. The anomaly detection system according to claim 1, wherein:
each p-stable random vector (lᵢ) is randomly sampled from a p-stable distribution 1.

16. The anomaly detection system according to claim 1, wherein:
a first device of the system is configured to calculate the hash functions (hᵢ(x)), and the sketch matrix is stored in a second device of the anomaly detection system, external to the first device.

17. The anomaly detection system according to claim 16, wherein the first device is a microcontroller.

18. The anomaly detection system according to claim 1, wherein the data stream is stationary.

19. The anomaly detection system according to claim 1, wherein the anomaly detection system is a microcontroller.

20. A computer-implemented in-situ anomaly detection method comprising, in an in-situ learning phase and/or in an inference phase:
acquiring, by one or more processors, a data stream; and
determining, by the one or more processors, an M*N sketch matrix (S_{i,j}) using a Count-Min sketching algorithm (CMS) based on hash functions (hᵢ(x)) of hash keys (x) associated with the data stream;
each of the hash functions (hᵢ(x)) comprising a projection, of a p-stable random projection matrix (Πᵢ) multiplied by the hash keys x, onto a direction of a p-stable random vector (lᵢ).
